(19) United States
(12) Patent Application Publication
(10) Pub. No.: US 2025/0218403 A1
(43) Pub. Date: Jul. 3, 2025

(54) Display Device, Subpixel, and Driving Method

(71) Applicant: LG Display Co., Ltd., Seoul (KR)

(72) Inventors: Jongmin Park, Paju-si (KR); Yunki Won, Paju-si (KR)

(21) Appl. No.: 18/911,528

(22) Filed: Oct. 10, 2024

(30) Foreign Application Priority Data
Dec. 28, 2023 (KR) 10-2023-0194431
Jul. 12, 2024 (KR) 10-2024-0092331

(51) Int. Cl. G09G 3/3291; G09G 3/3266

(52) U.S. Cl. CPC G09G 3/3291; G09G 3/3266; G09G 2300/0842; G09G 2310/0216; G09G 2310/0294; G09G 2310/08; G09G 2320/0233

(57) ABSTRACT

A subpixel circuit of a display device comprises a driving transistor, a first transistor controlled by the scanning signal and electrically connected to gate and drain nodes of the driving transistor; a second transistor controlled by the scanning signal and electrically connected to a source node of the driving transistor and the data line; a third transistor controlled by the emission control signal and electrically connected to a high potential voltage supply line and the source node of the driving transistor; a fourth transistor controlled by the emission control signal and electrically connected to the drain node of the driving transistor and the light-emitting element; and a fifth transistor controlled by the scanning signal and electrically connected to an initializing voltage supply line and the light-emitting element. The number of signal lines are reduced by forming a scanning signal line and an emission control signal line into an integrated structure.

### CROSS REFERENCE TO RELATED APPLICATION

This application claims priority from Republic of Korea Patent Application No. 10-2023-0194431 filed on Dec. 28, 2023, and Republic of Korea Patent Application No. 10-2024-0092331 filed on Jul. 12, 2024, each of which is hereby incorporated by reference in its entirety.

### BACKGROUND

### Field

Embodiments of the disclosure relate to a display device, a subpixel, and a method of driving the display device.

### Description of Related Art

Organic light-emitting display devices that have recently come to prominence have advantages, such as rapid response rates, high emission efficiency, high luminous intensity, and wide viewing angles, since self-luminous organic light-emitting diodes (OLEDs) are used therein.

In an organic light-emitting display device, subpixels each including an OLED and driving transistors for driving the OLED are arranged in a matrix form, and the brightness of each of the subpixels selected by scanning signals is controlled according to the gradation of the data.

In an organic light-emitting display device, an OLED and a driving transistor for driving the OLED are disposed in each of the subpixels defined on the display panel, and the characteristic values (e.g., threshold voltage or mobility) of the driving transistors in each of the subpixels may change depending on the driving time, or the difference in the driving time of each of the subpixels may cause deviations in the characteristics of the transistors. This may cause a luminance deviation (luminance unevenness) between the subpixels, thereby resulting in poor image quality.

In conventional organic light-emitting display devices, to resolve luminance deviations between subpixels, sensing and compensation technologies have been proposed to sense and compensate for deviations in characteristic values between the driving transistors. However, a method of storing a charge corresponding to an image displaying data voltage in a storage capacitor during a data write period may be influenced by a parasitic capacitor. This may result in poor image quality.

### SUMMARY

Embodiments of the disclosure may provide a display device, a subpixel, and a method of driving the display device that are almost completely uninfluenced by a parasitic capacitor.

Embodiments of the disclosure may provide a display device, a subpixel, and a method of driving the display device, in which the number of conductive or signal lines may be reduced by forming a scanning signal line and an emission control signal line into an integrated structure.

A display device according to embodiments of the disclosure may include: a display panel on which a data line intersects a gate line, and a plurality of subpixels are arranged; a data driver supplying a data signal to the data line; a gate driver supplying a scanning signal and an emission control signal to the gate line. Each of the subpixels may include a subpixel circuit. The subpixel circuit including: a driving transistor driving a light-emitting element; a first transistor controlled by the scanning signal and electrically connected to a gate node and a drain node of the driving transistor, a second transistor controlled by the scanning signal and electrically connected to a source node of the driving transistor and the data line; a third transistor controlled by the emission control signal and electrically connected to a high potential voltage supply line and the source node of the driving transistor; a fourth transistor controlled by the emission control signal and electrically connected to the drain node of the driving transistor and the light-emitting element; and a fifth transistor controlled by the scanning signal and electrically connected to an initializing voltage supply line and the light-emitting element.

Gate nodes of the first transistor, the second transistor, and the fifth transistor may be connected in common to a single scanning signal line. Gate nodes of the third transistor and the fourth transistor may be connected in common to a single emission control signal line.

A subpixel according to embodiments of the disclosure may include: a light-emitting element; a driving transistor driving the light-emitting element; a first transistor controlled by a scanning signal and electrically connected to a gate node and a drain node of the driving transistor; a second transistor controlled by the scanning signal and electrically connected to a source node of the driving transistor and a data line; a third transistor controlled by an emission control signal and electrically connected to a high potential voltage supply line and the source node of the driving transistor; a fourth transistor controlled by the emission control signal and electrically connected to the drain node of the driving transistor and the light-emitting element; and a fifth transistor controlled by the scanning signal and electrically connected to an initializing voltage supply line and the light-emitting element.

Gate nodes of the first transistor, the second transistor, and the fifth transistor may be connected in common to a single scanning signal line. Gate nodes of the third transistor and the fourth transistor may be connected in common to a single emission control signal line.

One frame time for driving of the subpixel according to embodiments of the disclosure may include: a first period (i.e., an initializing period) in which the source node of the driving transistor has a high potential voltage supplied through the high potential voltage supply line, and the gate node of the driving transistor has an initializing voltage supplied through the initializing voltage supply line, and a second period (i.e., a sampling period) in which the source node of the driving transistor has a data voltage supplied through the data line, and the gate node of the driving transistor has a different tracking voltage from the data voltage.

The tracking voltage may correspond to a voltage at which an absolute value of a threshold voltage of the driving transistor is subtracted from the data voltage.

During the first period, the initializing voltage may be applied to the gate node of the driving transistor through the fifth transistor, the fourth transistor, and the first transistor.

A method of driving a display device according to embodiments of the disclosure may include: a first operation (i.e., an initializing period) of applying a high potential voltage to a source node of the driving transistor and applying an initializing voltage to a gate node of the driving transistor; and a second operation (i.e., a sampling period) of applying a data voltage to the source node of the driving transistor.

In the second operation, the driving transistor may be in a diode-connection state, and the gate node of the driving transistor may have a tracking voltage different from the data voltage.

In the second operation, a first transistor connected to a drain node and the gate node of the driving transistor may be turned on so that the driving transistor is in a diode-connection state.

The tracking voltage may correspond to a voltage at which an absolute value of the threshold voltage of the driving transistor is subtracted from the data voltage.

In the first operation, the initializing voltage may be applied to the gate node of the driving transistor through the first transistor.

According to embodiments of the disclosure, a method of writing an image displaying data voltage directly to the driving transistor during the sensing phase, rather than a method of charging the storage capacitor with a charge corresponding to the image displaying data voltage during a data writing process, may be used so as to be almost completely uninfluenced by a parasitic capacitor.

According to embodiments of the disclosure, data may be delivered directly to the driving transistor, rather than being delivered to the driving transistor by capacitive coupling, thereby enabling accurate data writing to be accomplished without the influence of a parasitic capacitor.

According to embodiments of the disclosure, the number of conductive or signal lines may be reduced by forming the scanning signal line and the emission control signal line into an integrated structure. Accordingly, the aperture ratio of the display panel may be increased.

### BRIEF DESCRIPTION OF DRAWINGS

FIG. 1 is a schematic view illustrating a system configuration of a display device according to embodiments of the disclosure;

FIG. 2 is a perspective view illustrating an example system of the display device according to embodiments of the disclosure;

FIG. 3 illustrates an equivalent circuit of a subpixel SP according to embodiments of the disclosure;

FIG. 4 illustrates an equivalent circuit of a subpixel SP according to other embodiments of the disclosure;

FIG. 5 is a flowchart illustrating a method of driving the display device according to embodiments of the disclosure;

FIG. 6 is a diagram illustrating gate signals applied to a subpixel of the display device during subpixel driving according to embodiments of the disclosure;

FIG. 7 is circuit and timing diagram illustrating the driving of the display device during the initializing period according to embodiments of the disclosure;

FIG. 8 is circuit and timing diagram illustrating the driving of the display device during the sampling period according to embodiments of the disclosure;

FIG. 9 is circuit and timing diagrams illustrating the driving of the display device during the holding period according to embodiments of the disclosure;

FIG. 10 is circuit and timing diagram illustrating the driving of the display device during the emission period according to embodiments of the disclosure;

FIG. 11 illustrates an example signal line configuration of the display device according to embodiments of the disclosure;

FIG. 12 is a diagram illustrating gate signals applied according to driving timing in which emission periods are maintained the same in a subpixel of the display device according to embodiments of the disclosure; and

FIG. 13 is a diagram illustrating gate signals that maintain emission periods the same in a single frame in the display panel of the display device according to embodiments of the disclosure.

### DETAILED DESCRIPTION

Hereinafter, some embodiments of the present disclosure will be described in detail with reference to exemplary drawings. In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description may make the subject matter in some embodiments of the present invention rather unclear. The terms such as “including”, “having”, “containing”, “constituting”, “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together. In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to the accompanying drawings.

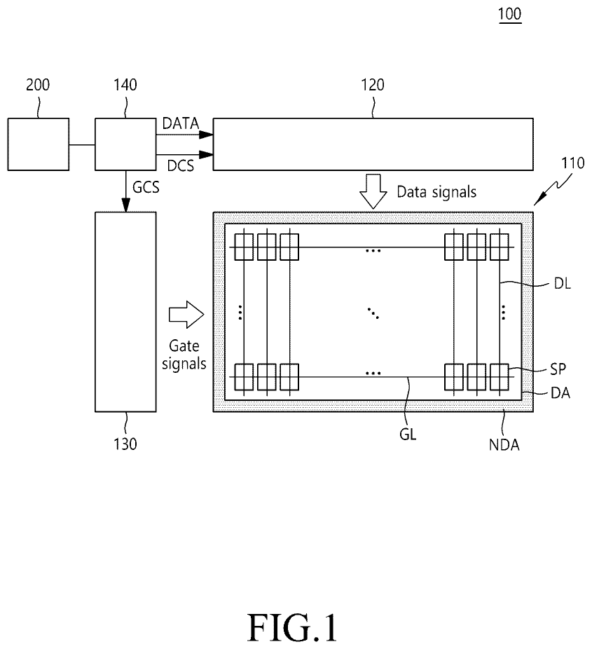

FIG. 1 is a schematic view illustrating a system configuration of a display device according to embodiments of the disclosure.

Referring to FIG. 1, a display device 100 according to the present embodiment may include a display panel 110 on which a plurality of data lines DL and a plurality of gate lines GL are disposed, and a plurality of subpixels SP defined by the plurality of data lines DL and the plurality of gate lines GL are arranged in a matrix form, and a driver circuit for driving the display panel 110.

The driver circuit may include, with terms of functions, a data driver circuit 120 driving the plurality of data lines DL, a gate driver circuit 130 driving the plurality of gate lines GL, a controller 140 controlling the data driver circuit 120 and the gate driver circuit 130, and the like.

In the display panel 110, the plurality of data lines DL and the plurality of gate lines GL may be arranged to intersect each other. For example, the plurality of gate lines GL may be arranged in rows or columns, and the plurality of data lines DL may be arranged in columns or rows. In the following, for the sake of brevity, it is taken that the plurality of gate lines GL are arranged in rows and the plurality of data lines DL are arranged in columns.

In addition to the plurality of data lines DL and the plurality of gate lines GL, other types of lines (e.g., conductive lines or signal lines) may be disposed on the display panel 110.

The controller 140 may supply image data (or video data) DATA to the data driver circuit 120.

In addition, the controller 140 may control the operation of the data driver circuit 120 and the gate driver circuit 130 by supplying various control signals DCS and GCS necessary for the operation of the data driver circuit 120 and the gate driver circuit 130.

The controller 140 starts scanning according to the timing implemented for each frame, converts the externally input image data into a data signal format readable by the data driver circuit 120, outputs the converted image data DATA, and controls the data driving at a suitable time according to the scanning.

To control the data driver circuit 120 and the gate driver circuit 130, the controller 140 receives timing signals, such as a vertical synchronization signal (Vsync), a horizontal synchronization signal (Hsync), an input data enable signal (DE), and a clock (CLK) from an external source (e.g., a host system 200), generates various control signals, and outputs the generated control signals to the data driver circuit 120 and the gate driver circuit 130.

For example, the controller 140 outputs various gate control signals GCS, including a gate start pulse (GSP), a gate shift clock (GSC), a gate output enable signal (GOE), and the like, to control the gate driver circuit 130.

The controller 140 also outputs various data control signals DCS, including a source start pulse (SSP), a source sampling clock (SSC), a source output enable signal (SOE), and the like, to control the data driver circuit 120.

The controller 140 may be a timing controller used in conventional display technology, or may be a controller that may include a timing controller and further perform other control functions.

The controller 140 may be implemented as a separate component from the data driver circuit 120, or may be integrated with the data driver circuit 120 to form an integrated circuit.

The data driver circuit 120 receives image data DATA from the controller 140 and supplies data voltage to the plurality of data lines DL to drive the plurality of data lines DL. Here, the data driver circuit 120 is also referred to as a source driver circuit.

The data driver circuit 120 may include a shift register, a latch circuit, a digital-to-analog converter (DAC), an output buffer, and the like.

The data driver circuit 120 may further include, in some cases, one or more analog-to-digital converters (ADCs).

The gate driver circuit 130 sequentially drives the plurality of gate lines GL by sequentially supplying scanning signals to the plurality of gate lines GL. The gate driver circuit 130 is also referred to as a scanning driver circuit.

The gate driver circuit 130 may include a shift register, a level shifter, and the like.

The gate driver circuit 130 sequentially supplies scanning signals of an on voltage or an off voltage to the plurality of gate lines GL, under the control of the controller 140.

When a specific gate line is opened by the gate driver circuit 130, the data driver circuit 120 converts the image data DATA received from the controller 140 into an analog format data voltage and supplies the converted data voltage to the plurality of data lines DL.

The data driver circuit 120 may be located on one side (e.g., a top or bottom side) of the display panel 110, or in some cases, may be located on both sides (e.g., both the top and bottom sides) of the display panel 110, depending on the driving method, the design of the display panel, or the like.

The gate driver circuit 130 may be located on one side (e.g. a right or left side) of the display panel 110, or in some cases, may be located on both sides (e.g. both the right and left sides) of the display panel DISP, depending on the driving method, the design of the display panel, or the like.

The data driver circuit 120 may be implemented including at least one source driver integrated circuit SDIC.

Each source driver integrated circuit may be connected to a bonding pad on the display panel 110 by a tape-automated bonding (TAB) method or a chip-on-glass (COG) method, or may be disposed directly on the display panel 110. In some cases, each source driver integrated circuit may be disposed as an integrated portion of the display panel 110. In addition, each source driver integrated circuit may be implemented by a chip-on-film (COF) method. In this case, the respective source driver integrated circuits may be mounted on circuit films and electrically connected to the data lines DL on the display panel 110 through the circuit films.

The gate driver circuit 130 may include one or more gate driver integrated circuits GDIC connected to the bonding pads of the display panel 110 by a TAB method or a COG method. The gate driver circuit 130 may also be implemented by a gate-in-panel (GIP) method and disposed directly on the display panel 110. Furthermore, the gate driver circuit 130 may be implemented by a COF method. In this case, the respective gate driver integrated circuits included in the gate driver circuit 130 may be mounted on circuit films and electrically connected to the gate lines GL on the display panel 110 through the circuit films.

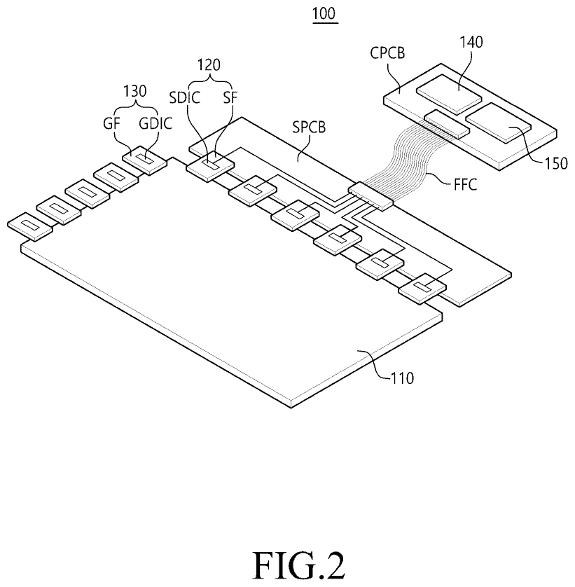

FIG. 2 is a perspective view illustrating an example system of the display device 100 according to one embodiment.

Referring to FIG. 2 together with FIG. 1, the display panel 110 may include a display area DA where an image is displayed and a non-display area NDA where no image is displayed.

According to the implementation example of FIG. 2, the data driver circuit 120 may include a plurality of source driver integrated circuits SDIC, and may be implemented by a chip-on-film (COF) method. The plurality of source driver integrated circuits SDIC may be mounted on source-side circuit films SF connected to the non-display area NDA of the display panel 110. Here, the source-side circuit films SF may also be referred to as flexible printed circuits.

According to the implementation example of FIG. 2, the gate driver circuit 130 may be implemented by a GIP method. In the following, the gate driver circuit 130 implemented by the GIP method is also referred to as a “gate driver panel circuit (GPC)”.

The gate driver panel circuit may be provided in the non-display area NDA of the display panel 110. According to the implementation example of FIG. 2, the gate driver panel circuit may be disposed in both the non-display area NDA located on one peripheral portion of the display area DA and the non-display area NDA located on the other peripheral portion of the display area DA.

A plurality of gate driver integrated circuits GDIC included in the gate driver panel circuit may be mounted on gate-side circuit films GF, respectively.

The plurality of source driver integrated circuits SDIC included in the data driver circuit 120 may be mounted on source-side circuit films SF, respectively.

First sides of the source-side circuit films SF may be electrically connected to the display panel 110. Lines may be disposed over the source-side circuit films SF to electrically connect the source driver integrated circuits SDIC to the display panel 110.

The display device 100 may include at least one source printed circuit board SPCB for circuit connection between the plurality of source driver integrated circuits SDIC and other devices (e.g., 140, L/S, and PMIC) and a control printed circuit board CPCB allowing control components and various electrical devices to be mounted thereon.

The at least one source printed circuit board SPCB may be connected to the source-side circuit films SF on which the source driver integrated circuits SDIC are mounted. That is, each of the source-side circuit films SF on which the source driver integrated circuits SDIC are mounted may be electrically connected on one side thereof to the display panel 110 and electrically connected at the other side thereof to the source printed circuit board SPCB.

The at least one source printed circuit board SPCB may be connected to the other sides of the source-side circuit films SF on which the source driver integrated circuits SDIC are mounted.

The control printed circuit board CPCB may allow the controller 140, a power management integrated circuit (PMIC) 150, and the like to be mounted thereon.

The controller 140 may perform overall control functions related to the operation of the display panel 110, and may control the operation of the plurality of source driver integrated circuits SDIC and the gate driver panel circuit.

The power management integrated circuit 150 may supply or control various voltages or currents, or control various voltages or currents to be supplied, to the plurality of source driver integrated circuits SDIC and the gate driver panel circuit, and the like.

The at least one source printed circuit board SPCB and the control printed circuit board CPCB may be circuit-connected by at least one connecting cable (CBL). The connecting cable (CBL) may be one of, for example, a flexible printed circuit (FPC) or a flexible flat cable (FFC).

The at least one source printed circuit board SPCB and the control printed circuit board CPCB may be integrated into a single printed circuit board.

The display device 100 may further include a level shifter (L/S) for adjusting the voltage levels of signals. For example, the level shifter (L/S) may be disposed on the control printed circuit board CPCB or the source printed circuit board SPCB.

In the display device 100, the level shifter (L/S) may output signals required for gate driving to the gate driver panel circuit, which is the GIP type gate driver circuit 130.

For example, the power management integrated circuit 150 may output signals to the level shifter (L/S). The level shifter (L/S) may adjust the voltage levels of signals input from the power management integrated circuit 150. Signals having a voltage level adjusted by the level shifter (L/S) may be input to the gate driver panel circuit.

For example, the level shifter (L/S) may output a plurality of clock signals having different phases to the gate driver panel circuit. The gate driver panel circuit may generate a plurality of gate signals (e.g., scanning signals (SC) and sensing signals (SE)) based on the plurality of clock signals input from the level shifter (L/S) and output the plurality of gate signals to the plurality of gate lines (e.g., scanning signal lines (SCL) and sensing signal lines (SENL)).

Referring to FIG. 2, the non-display area NDA of the display panel 110 may include a gate bezel area. The gate bezel area may refer to an area where the gate driver panel circuit, which is the GIP type gate driver circuit 130, and various lines connected to the gate driver panel circuit are disposed.

Referring to FIG. 2, various lines connected to the gate driver panel circuit may include a plurality of clock lines, high-level gate voltage lines, and low-level gate voltage lines.

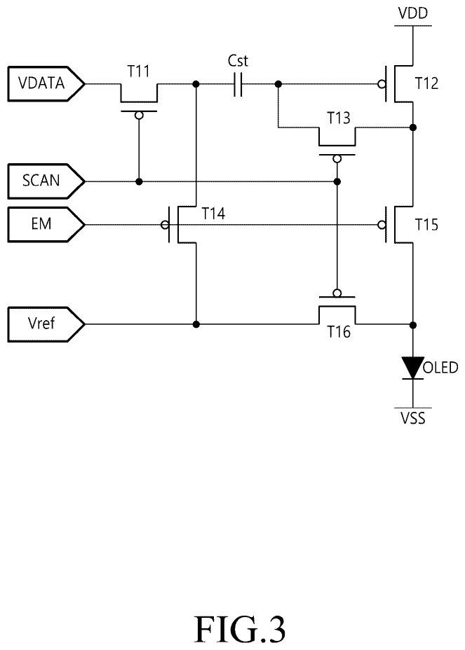

FIG. 3 illustrates an equivalent circuit of a subpixel SP according to embodiments of the disclosure.

Referring to FIG. 3, an organic light-emitting diode OLED, a plurality of display driving transistors for driving the organic light-emitting diode OLED, and a storage capacitor Cst may be disposed, in each of subpixels SP arranged in the display panel 110.

FIG. 3 illustrates a 6TIC structure including six display driving transistors T11, T12, T13, T14, T15, and T16 and a single storage capacitor Cst disposed in the subpixel SP as an example, in which the subpixel SP may be implemented in various forms depending on the number of circuit elements disposed therein and the connecting relationship thereof.

In the display device (i.e., a stretchable display device) according to the present embodiments, a 6TIC 1SCAN/1EM integrated structure may be used for compensation of a threshold voltage Vth and a voltage drop (i.e., IR drop) of a driving transistor. Here, the 1SCAN/1EM integrated structure may reduce the number of wiring lines compared to the conventional structure by integrating a scanning signal line and an emission control signal line.

A case in which the display driving transistors disposed in the subpixel SP are P-type transistors is shown as an example, but the subpixel SP may also be provided with N-type display driving transistors.

The transistor T11 may be located between and electrically connected to the data driver circuit 120 supplying a data voltage and a storage capacitor Cst. In addition, the transistor T11 may be controlled by a scanning signal SCAN supplied through the gate line GL.

When a scanning signal having a turn-on level is applied through the gate line GL, the transistor T11 causes a data voltage VDATA supplied from the data driver circuit 120 to be applied to one side of the storage capacitor Cst.

The transistor T12 may be located between and electrically connected to a line through which a high potential voltage VDD is supplied and the transistor T15. In addition, the gate electrode of the transistor T12 may be electrically connected to the storage capacitor Cst.

The transistor T12 is also referred to as a driving transistor, and may control the current flowing to the organic light-emitting diode OLED according to the voltage applied to the gate electrode of the transistor T12, thereby controlling the brightness expressed by the organic light-emitting diode OLED.

The transistor T13 may be located between and electrically connected to the gate electrode and the drain electrode or source electrode of the transistor 12. In addition, the transistor T13 may be controlled by the scanning signal SCAN supplied through the gate line GL.

This transistor T13 is designed to compensate for the threshold voltage of the transistor T12, and is also referred to as a compensation transistor.

In other words, the transistor T12 is a driving transistor that should control the current flowing to the organic light-emitting diode OLED according to the data voltage applied to the subpixel SP, but the light-emitting elements, i.e., the organic light-emitting diodes OLED, disposed in the subpixels SP may not express the intended brightness due to deviations in the threshold voltages of the transistors T12 disposed in the subpixels SP.

Accordingly, the threshold voltage of the transistor T12 disposed in each subpixel SP may be compensated for by the transistor T13.

Specifically, an initializing period, a sampling period, a data write period, and an emission period are executed in the subpixel SP, and the threshold voltage may be compensated for by such executions.

For example, when a scanning signal for turning the transistor T13 on is applied through the gate line GL, a voltage equal to the high potential voltage VDD minus the threshold voltage of the transistor T12 is applied to the gate electrode of the transistor T12.

By applying a data voltage to one side of the storage capacitor Cst in a state in which the high potential voltage VDD, from which the threshold voltage is subtracted, is applied to the gate electrode of the transistor T12, the threshold voltage of the transistor T12 may be compensated for.

That is, during the emission period, the current flowing through the transistor T12 and the current supplied to the organic light-emitting diode OLED are the same, and the following equation is established.

Ioled=K*[Vsg−|Vth|]²=K*[VDD−VDATA+|Vth|−|Vth|]²=K*[VDD−VDATA]²

As described above, it may be seen that since the threshold voltage Vth is canceled from the equation for finding the current Ioled supplied to the organic light-emitting diode OLED, the current Ioled flowing to the organic light-emitting diode OLED is not influenced by the threshold voltage Vth of the transistor T12.

That is, since the influence of the threshold voltage Vth is eliminated during subpixel driving, threshold voltage compensation occurs naturally during the subpixel driving.

Here, the transistor T11 controlling the application of the data voltage to one side of the storage capacitor Cst and the transistor T13 that compensates for the threshold voltage of the transistor T12 may be controlled by a scanning signal supplied to the same gate line, or may be controlled by scanning signals supplied to different gate lines GL.

In this manner, by compensating for the deviation of the threshold voltage of the transistor T12 by the transistor T13, the deviation of luminance expressed by the subpixel SP due to the difference in the threshold voltage of the transistor T12 may be prevented or at least reduced.

The transistor T14 may be located between and electrically connected to the storage capacitor Cst and a line through which a reference voltage Vref is supplied. In addition, the transistor T14 may be controlled by an emission control signal EM supplied through the gate line GL.

Such a transistor T14 may initialize the voltage on one side of the storage capacitor Cst when an emission control signal EM having a turn-on level is applied through the gate line GL, or may gradually discharge a data voltage VDATA applied to one side of the storage capacitor Cst and allow current according to the data voltage VDATA to flow to the organic light-emitting diode OLED.

In other words, the data voltage VDATA stored in the storage capacitor Cst is applied to the gate node of the transistor T12 during the emission period, thereby causing the transistor T12 to regulate the current Ioled flowing to the organic light-emitting diode OLED.

Specifically, the voltage of the gate node and the voltage of the drain node of the transistor T12 determined during the data writing period (or writing period) may cause a current to flow to the transistor T12, thereby supplying an intended current to the organic light-emitting diode OLED. Accordingly, the organic light-emitting diode OLED may adjust the brightness by the data voltage VDATA.

However, this method of writing data by applying the data voltage VDATA stored in the storage capacitor Cst to the gate node of the driving transistor has the disadvantage of being influenced by the parasitic capacitor caused by the storage capacitor Cst.

In a state in which the data voltage is applied to one side of the storage capacitor Cst and the high potential voltage VDD with the threshold voltage compensated is applied to the gate electrode of the transistor T12, when the emission control signal of the turn-on level is applied, the transistor T15 may be turned on, thereby allowing a current to flow to the organic light-emitting diode OLED.

Such transistors T14 and T15 control the emission timing of the organic light-emitting diode OLED, and are therefore also referred to as light-emitting transistors.

The transistor T16 may be located between and electrically connected to the line through which the reference voltage Vref is supplied and the anode of the organic light-emitting diode OLED. In addition, the transistor T16 may be controlled by a scanning signal SCAN supplied through the gate line GL.

When a scanning signal having a turn-on level is applied through the gate line GL, the transistor T16 may apply a reference voltage Vref to the anode of the organic light-emitting diode OLED, or may, for example, initialize the node between the transistor T12 and the transistor T15 with the reference voltage Vref during the initializing period.

As described above, the display driving transistors disposed in the subpixel SP are driven by the scanning signal and the emission control signal, and allow the current according to the data voltage to flow to the organic light-emitting diode OLED, thereby enabling the subpixel SP to express the brightness according to the image data.

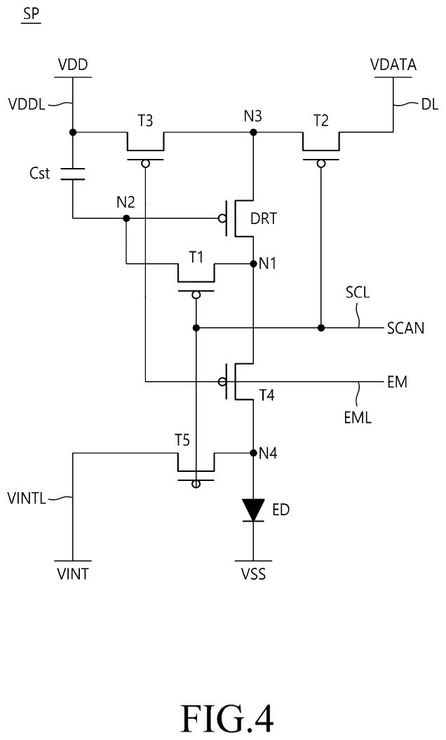

FIG. 4 illustrates an equivalent circuit of a subpixel SP according to other embodiments of the disclosure.

Referring to FIG. 4, a light-emitting element ED and a plurality of display driving transistors for driving the light-emitting element ED may be disposed in each of subpixels SP arranged in the display panel 110. The equivalent circuit of the subpixel shown in FIG. 4 differs from the equivalent circuit of the subpixel shown in FIG. 3 in that the storage capacitor Cst disposed on the node between transistor T11 and the transistor T12 as in the subpixel shown in FIG. 3 is not provided.

FIG. 4 illustrates a 6TIC structure including six display driving transistors DRT, T1, T2, T3, T4, and T5 and a single storage capacitor Cst disposed in the subpixel SP as an example, in which the subpixel SP may be implemented in various forms depending on the number of circuit elements disposed therein and the connecting relationship thereof.

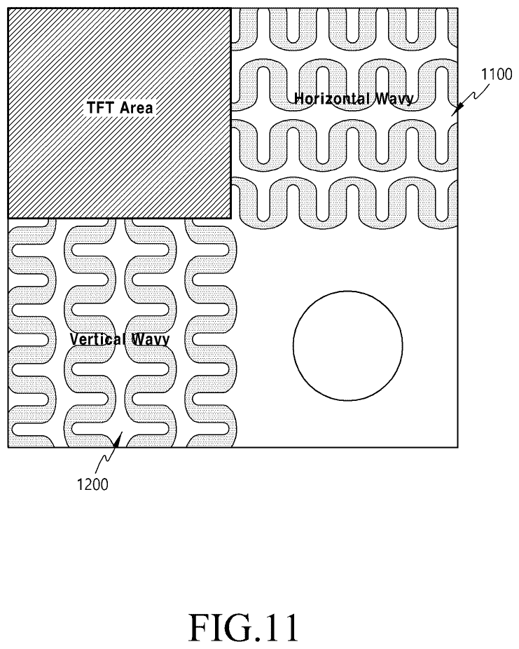

In the display device according to the present embodiments, a 6TIC 1SCAN/1EM integrated structure may be used for compensation of a threshold voltage Vth and a voltage drop (i.e., IR drop) of the driving transistor DRT. Since the sub-pixel SP is configured to be driven by only a single scanning signal SCAN and a single emission control signal EM as described above, the number of a plurality of transverse signal lines 1100 (see FIG. 11) including the gate lines GL disposed on the display panel 110 may be reduced, thereby further improving the stretchability characteristics of the display device 100.

In addition, a case where the driving transistor DRT disposed in the subpixel SP is a P-type transistor is shown as an example, but the subpixel SP may also be implemented to include an N-type driving transistor DRT.

The subpixel is initialized with the data voltage VDATA and then driven by an internal compensation method by sensing the threshold voltage of the driving transistor DRT.

The light-emitting element ED includes a first electrode, a second electrode, and a light-emitting layer located between the first electrode and the second electrode. The first electrode of the light-emitting element ED may be an anode or a cathode, and the second electrode may be a cathode or an anode. The light-emitting element ED may be, for example, an organic light-emitting diode (OLED), a mineral-based light-emitting diode (LED), a quantum dot LED, or the like.

The second electrode of the light-emitting element ED may be a common electrode. In this case, the second electrode of the light-emitting element ED may be applied with a base voltage VSS. Here, the base voltage VSS may be, for example, a ground voltage or a voltage similar to the ground voltage.

The driving transistor DRT is a transistor for driving the light-emitting element ED, and includes a first node N1, a second node N2, and a third node N3.

The second node N2 of the driving transistor DRT may be a node corresponding to a gate node (also referred to as a gate electrode), which may be electrically connected to the storage capacitor Cst and the first transistor T1. The first node N1 of the driving transistor DRT may be a drain node (also referred to as a drain electrode) or a source node (also referred to as a source electrode) of the driving transistor DRT, may be electrically connected to the source node or the drain node of the first transistor T1, and may be electrically connected to the source node or the drain node of the fourth transistor T4. The third node N3 of the driving transistor DRT may be a source node or a drain node of the driving transistor DRT, may be electrically connected to a source node or a drain node of the second transistor T2, and may be electrically connected to a source node or a drain node of the third transistor T3.

The driving transistor DRT may be turned on according to the voltage applied to the second node N2, which is the gate node, to supply a current to the light-emitting element ED, thereby causing the light-emitting element ED to emit light.

The first transistor T1 may be electrically connected to the first node N1 and the second node N2 of the driving transistor DRT. In addition, the first transistor T1 may be controlled by a scanning signal SCAN supplied through the scanning signal line SCL. The scanning signal line SCAL may a type of gate line GL.

The second transistor T2 may be located between and electrically connected to the third node N3 of the driving transistor DRT and the data line DL, and may be controlled by a scanning signal SCAN supplied through the scanning signal line SCL.

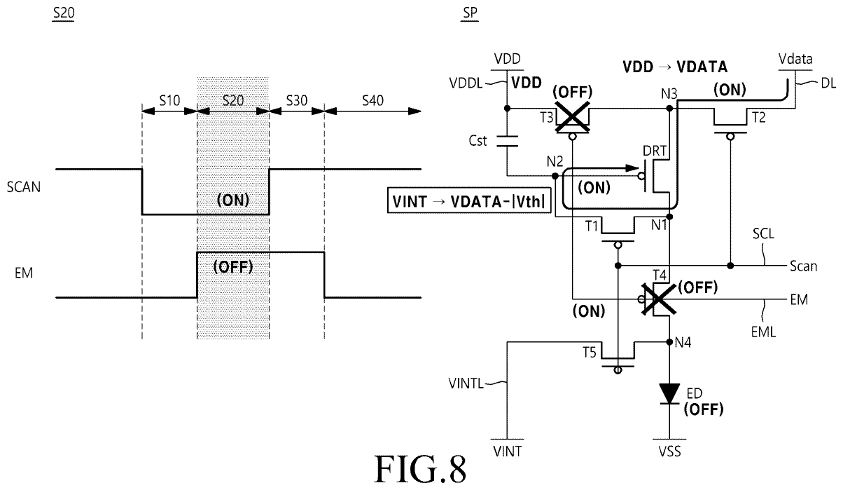

For example, referring to FIG. 8, during the sampling period S20, in a state in which the scanning signal SCAN for turning on the first transistor T1 and the second transistor T2 is applied through the scanning signal line SCL, the second node N2, which is the gate node, of the driving transistor DRT has a voltage VDATA−|Vth| at which the absolute value |Vth| of the threshold voltage of the driving transistor DRT is subtracted from the data voltage VDATA. Here, the difference VDATA−|Vth| between the data voltage VDATA and the absolute value |Vth| of the threshold voltage of the driving transistor DRT may be referred to as the tracking voltage.

During the sampling period S20, the potential of the second node N2 increases to be saturated into a voltage (i.e., a tracking voltage) the magnitude of which corresponds to the voltage VDATA−|Vth| at which the absolute value |Vth| of the threshold voltage of the driving transistor DRT is subtracted from the data voltage VDATA.

In other words, during the sampling period, the gate-source potential difference, i.e., the voltage difference between the second node N2 and the third node N3, of the driving transistor DRT may correspond to the magnitude of the threshold voltage.

When the data voltage VDATA−|Vth| compensated for the threshold voltage is applied to the second node N2, which is the gate node, of the driving transistor DRT, and in that state, an emission control signal EM having a turn-on level is applied, the light-emitting element ED may be turned on, thereby allowing a current to flow to the light-emitting element ED.

The third transistor T3 may be located between and electrically connected to a high potential voltage supply line VDDL supplying a high potential voltage VDD and the third node N3 of the driving transistor DRT, and may be controlled by the emission control signal EM supplied through an emission control signal line EML.

When the emission control signal EM having a turn-on level is applied through the emission control signal line EML, the third transistor T3 allows the high potential voltage VDD to be applied to the third node N3 of the driving transistor DRT.

The fourth transistor T4 may be located between and electrically connected to the first node N1 of the driving transistor DRT and the anode of the light-emitting element ED. The fourth transistor T4 may be controlled by an emission control signal EM supplied through the emission control signal line EML. The emission control signal line EML may be a type of gate line GL.

The fourth transistor T4 may turn off the light-emitting element ED by blocking the current applied to the light-emitting element ED when the emission control signal EM having a turn-off level is applied through the emission control signal line EML. When the emission control signal EM having a turn-on level is applied through the emission control signal line EML, the third transistor T3 and the fourth transistor T4 may deliver a light-emitting element driving current flowing through the third node N3, the first node N1, and the fourth node N4 to the light-emitting element ED, thereby causing the light-emitting element ED to emit light.

Specifically, in a state in which a high potential voltage VDD is applied to one side of the storage capacitor Cst, and a data voltage VDATA−|Vth| with the threshold voltage compensated is applied to the second node N2, which is the gate node, of the driving transistor DRT, the fourth transistor T4 may be turned on in response to the application of the emission control signal EM having a turn-on level, thereby allowing a current to flow to the light-emitting element ED.

These third and fourth transistors T3 and T4 control the emission timing of the light-emitting element ED and are therefore also referred to as emission control transistors.

The fifth transistor T5 is controlled by a scanning signal SCAN, and may be located between and electrically connected to an initializing voltage supply line VINTL and the anode of the light-emitting element ED.

When the scanning signal SCAN of the turn-on level is applied through the scanning signal line SCL, the fifth transistor T5 may apply an initializing voltage VINT to the anode of the light-emitting element ED or initialize a node (i.e., the first node N1) between the driving transistor DRT and the fourth transistor T4.

In the subpixel SP of FIG. 4, the driving transistor DRT and the first to fifth transistors T1 to T5 may be P-type transistors. Accordingly, the driving transistors DRT and the first to fifth transistors T1 to T5 may be turned on by a gate voltage, which is a low-level voltage, and turned off by a gate voltage, which is a high-level voltage. However, this is not intended to be limiting, and the driving transistor DRT and the first to fifth transistors T1 to T5 may be N-type transistors. In this case, the driving transistor DRT and the first to fifth transistors T1 to T5 may be turned on by a high-level gate voltage and turned off by a low-level gate voltage.

In the following, for the sake of brevity, the driving transistor DRT and the first to fifth transistors T1 to T5 will be described as P-type transistors by way of example.

In addition, as described above, the subpixel shown in FIG. 3 is configured such that data is written by applying the data voltage VDATA stored in the storage capacitor Cst to the gate node of the driving transistor and thus has the disadvantage of being influenced by the parasitic capacitor formed by the storage capacitor Cst.

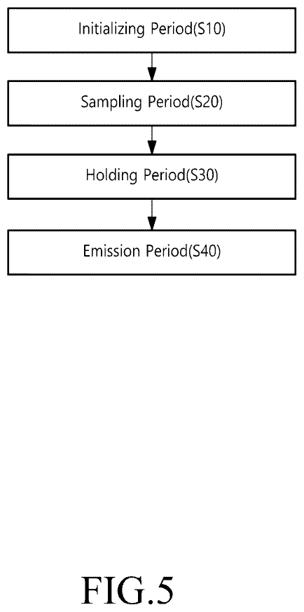

To improve this, embodiments of the disclosure may use a method of applying a data voltage directly to the gate node of the driving transistor from the data line in data write driving for a subpixel, rather than using a method of supplying a data voltage stored in the capacitor to the gate node of the driving transistor, in order to be less influenced by a parasitic capacitor. This will be described in detail below with reference to FIGS. 5 to 10.

Hereinafter, with reference to FIGS. 5 to 10, internal compensation driving for the display device 100 according to embodiments of the disclosure will be described.

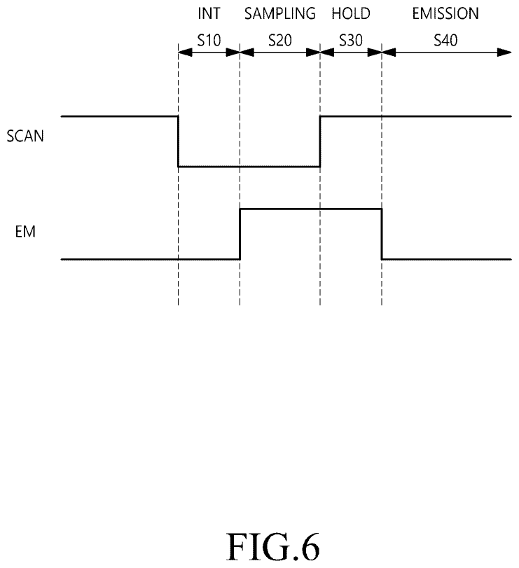

FIG. 5 is a flowchart illustrating a method of driving the display device 100 according to embodiments of the disclosure, and FIG. 6 is a diagram illustrating gate signals SCAN and EM applied to a subpixel SP of the display device 100 during driving for the subpixel SP according to embodiments of the disclosure.

Referring to FIGS. 5 and 6, the driving time of each subpixel SP of the display device 100 according to embodiments of the disclosure may include an initializing period (INT) S10, a sampling period (SAMPLING) S20, a holding period (HOLD) S30, and an emission period (EMISSION) S40.

Referring to FIGS. 5 and 6, the initializing period S10 is a period during which a voltage on the second node N2 and the third node N3 of the driving transistor DRT is initialized.

During the initializing period S10, the scanning signal SCAN and the emission control signal EM have a turn-on level voltage. Here, since the first to fifth transistors T1 to T5 are P-type transistors, the turn-on level voltage may be a low-level voltage and the turn-off level voltage may be a high-level voltage. In the following, the turn-on level voltage will also be referred to as the low-level voltage, and the turn-off level voltage will also be referred to as the high-level voltage.

The sampling period S20 is a period during which the threshold voltage of the driving transistor DRT is detected and stored. During the sampling period S20, the scanning signal SCAN has a turn-on level voltage and the emission control signal EM has a turn-off level voltage.

Here, each of the initializing period S10 and the sampling period S20 may be referred to as a sensing period during which the threshold voltage is sensed.

The holding period S30 is a phase (or a period) before the emission period S40 is started. During the holding period S30, the scanning signal SCAN and the emission control signal EM have a turn-off level voltage.

The emission period S40 is a period during which the light-emitting element ED emits light. During the emission period S40, the scanning signal SCAN has a turn-off level voltage and the emission control signal EM has a turn-on level voltage. Accordingly, a path for a current to flow to the light-emitting element ED may be formed.

Hereinafter, the driving method briefly described above with reference to FIGS. 5 and 6 will be described in more detail with respect to the initializing period S10, the sampling period S20, the holding period S30, and the emission period S40, respectively.

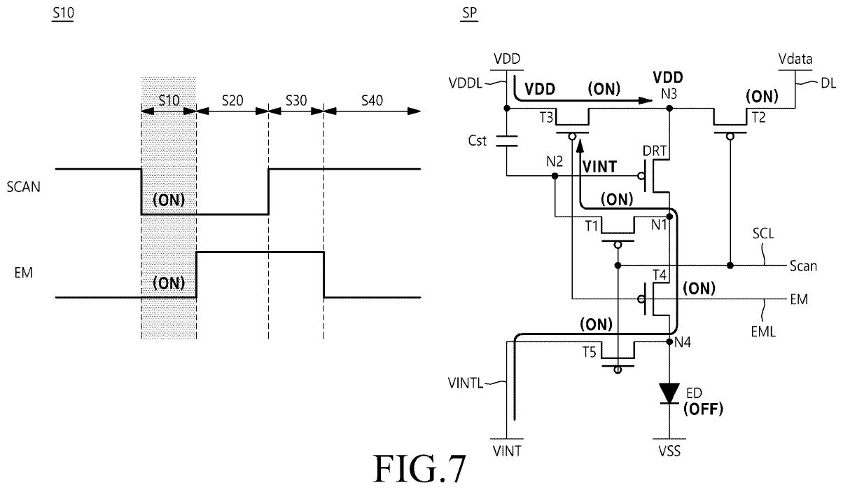

FIG. 7 is circuit and timing diagrams illustrating the driving of the display device 100 during the initializing period S10 according to embodiments of the disclosure.

Referring to FIG. 7, during the initializing period S10, the first transistor T1, the second transistor T2, and the fifth transistor T5 are turned on by a scanning signal SCAN having a turn-on level voltage, and the third transistor T3 and the fourth transistor T4 are turned on by an emission control signal EM having a turn-on level voltage.

Accordingly, the second node N2 and the third node N3 of the driving transistor DRT may be initialized by applying an initializing voltage VINT to the second node N2 of the driving transistor DRT and a high potential voltage VDD to the third node N3 of the driving transistor DRT.

In the initializing period S10, the initializing voltage VINT supplied to the second node N2 is for initializing a subpixel SP to a predetermined level, and the magnitude of the initializing voltage VINT is set to a voltage value lower than the operating voltage of the light-emitting element ED so that the light-emitting element ED does not emit light.

For example, the initializing voltage VINT may be set to a voltage having a magnitude of −1 V to +1 V, more preferably, a value of 0 V or less.

As the initializing voltage VINT is supplied to the second node N2 of the driving transistor DRT, a data voltage VDATA or a corresponding voltage written in a previous frame is initialized to the initializing voltage VINT.

FIG. 8 is circuit and timing diagrams illustrating the driving of the display device 100 during the sampling period S20 according to embodiments of the disclosure.

Referring to FIG. 8, during the sampling period S20 after the initializing period S10, the first transistor T1, the second transistor T2, and the fifth transistor T5 are turned on by a scanning signal SCAN having a turn-on level voltage. In addition, during the sampling period S20, the third transistor T3 and the fourth transistor T4 are turned off by an emission control signal EM having a turn-off level voltage.

During the sampling period S20, a data voltage VDATA is applied to the third node N3 of the driving transistor DRT through the second transistor T2. Accordingly, the voltage of the third node N3 may change from the high potential voltage VDD to the data voltage VDATA.

During the sampling period S20, the voltage of the second node N2 of the driving transistor DRT may change from the initializing voltage VINT applied for initialization in the previous period S10, and then saturate after a predetermined time has elapsed. The saturated voltage of the second node N2 may correspond to the difference between the data voltage VDATA and the absolute value |Vth| of the threshold voltage of the driving transistor DRT (saturated voltage of the second node=VDATA−|Vth|, where Vth may be a positive or negative value).

In particular, in the present disclosure, in the sampling period S20, a driving current flowing to the light-emitting element ED may be determined by performing data writing in which the data voltage VDATA is directly applied to the second node N2, which is the gate node of the driving transistor DRT.

In this regard, the image displaying data voltage must be applied to the gate node of the driving transistor DRT during the data write period for determining the driving current flowing to the light-emitting element ED.

Conventionally, as described with reference to FIG. 3, during the data write period, the data voltage VDATA stored in the storage capacitor Cst is supplied to the gate node of the driving transistor.

In contrast, as described above, during the sampling period in the subpixel according to embodiments shown in FIG. 4, the data voltage VDATA is applied to the third node N3 of the driving transistor DRT through the second transistor T2, so that the potential of the third node N3 becomes the data voltage VDATA. The voltage saturating in the second node N2 corresponds to the difference between the data voltage VDATA and the absolute value |Vth| of the threshold voltage of the driving transistor DRT.

Accordingly, it is not necessary to supply the data voltage VDATA stored in the capacitor to the second node N2 (i.e., the gate node) of the driving transistor DRT. In other words, it may be understood that the data voltage VDATA is supplied directly from the third node N3 to the second node N2 (i.e., the gate node) of the driving transistor DRT.

During the sampling period S20, as the fourth transistor T4 is turned off and the first node N1 is floated, the second node N2 of the driving transistor DRT may change from the initializing voltage VINT applied for initialization in the previous period S10 and, after a period of time, saturate to a voltage corresponding to VDATA−|Vth|.

That is, as the data voltage VDATA is applied to the third node N3 of the driving transistor DRT, and the first node N1 is floated by turn-off driving of the fourth transistor T4, the voltage at the second node N2 of the driving transistor DRT increases until the voltage is saturated to a magnitude corresponding to VDATA−|Vth|.

That is, after the sampling period S20, the gate-source potential difference, i.e., the voltage difference between the second node N2 and the third node N3, of the driving transistor DRT may correspond to the magnitude of the threshold voltage Vth, wherein the threshold voltage Vth is stored in the storage capacitor Cst.

Here, the voltage of the third node N3 of the driving transistor DRT corresponds to the data voltage VDATA, and the voltage of the second node N2 of the driving transistor DRT corresponds to the voltage difference VDATA−|Vth| between the data voltage VDATA and the absolute value |Vth| of the threshold voltage.

Accordingly, the voltage difference between the third node N3 and the second node N2 of the driving transistor DRT becomes the magnitude of the threshold voltage Vth. As this threshold voltage is stored in the storage capacitor Cst, the threshold voltage is sampled.

In other words, it may be understood that in the sampling period S20, the gate-source potential difference, i.e., the voltage difference between the second node N2 and the third node N3, of the driving transistor DRT becomes the magnitude of the threshold voltage Vth, and that as the voltage corresponding to the threshold voltage magnitude is stored in the storage capacitor Cst, the threshold voltage of the driving transistor DRT is sampled.

The source-to-gate voltage (Vsg) of the driving transistor DRT maintains a voltage |Vth| according to the following equation:

Vsg=Vs−Vg=VDATA−VDATA−|Vth|=VDATA−VDATA+|Vth|=|Vth|

As described above, the internal compensation subpixel circuit according to embodiments of the disclosure does not perform data writing by a cap coupling method of supplying a data voltage stored in the capacitor applied to the subpixel structure shown in FIG. 3 to the gate node of the driving transistor, but may perform data writing by applying a data voltage directly to the gate node of the driving transistor DRT in the sampling period (the sensing period) S20 using the subpixel structure shown in FIG. 4, thereby being less influenced by the parasitic capacitor.

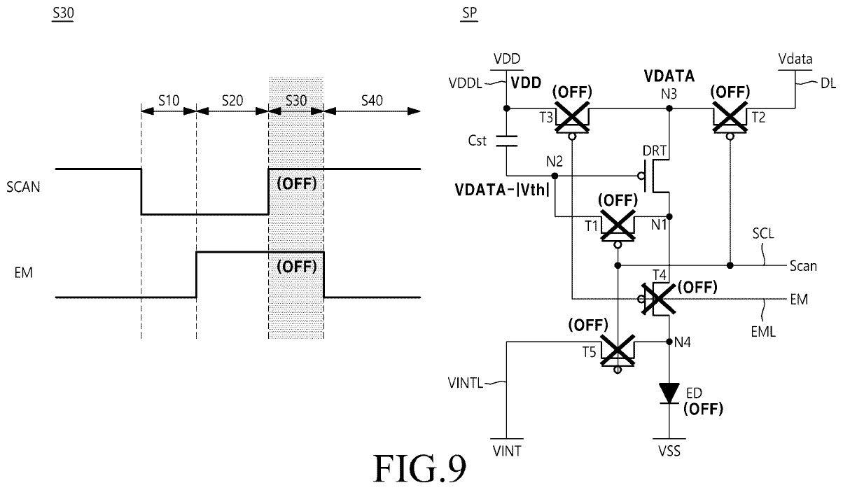

FIG. 9 is circuit and timing diagrams illustrating the driving of the display device 100 during the holding period S30 according to embodiments of the disclosure.

Referring to FIG. 9, during the holding period S30, the first transistor T1, the second transistor T2, and the fifth transistor T5 are turned off by the scanning signal SCAN having a turn-off level voltage. In addition, during the holding period S30, the third transistor T3 and the fourth transistor T4 are turned off by an emission control signal EM having a turn-off level voltage. Accordingly, during the holding period S30, the voltage on the second node N2 is maintained at a voltage corresponding to VDATA−|Vth|.

The third node N3 maintains a data voltage VDATA.

Here, Vs=VDATA=voltage of the third node N3=source node voltage of the driving transistor DRT.

During the holding period S30, the voltage of the first node N1 of the driving transistor DRT may increase by the conduction current of the driving transistor DRT. This may be a preparation process for light emission.

When the increased voltage of the first node N1 of the driving transistor DRT (i.e., the voltage of the first electrode of the light-emitting element ED) reaches a predetermined voltage (i.e., the voltage of the second electrode of the light-emitting element ED plus the threshold voltage of the light-emitting element ED), the light-emitting element ED starts emitting light.

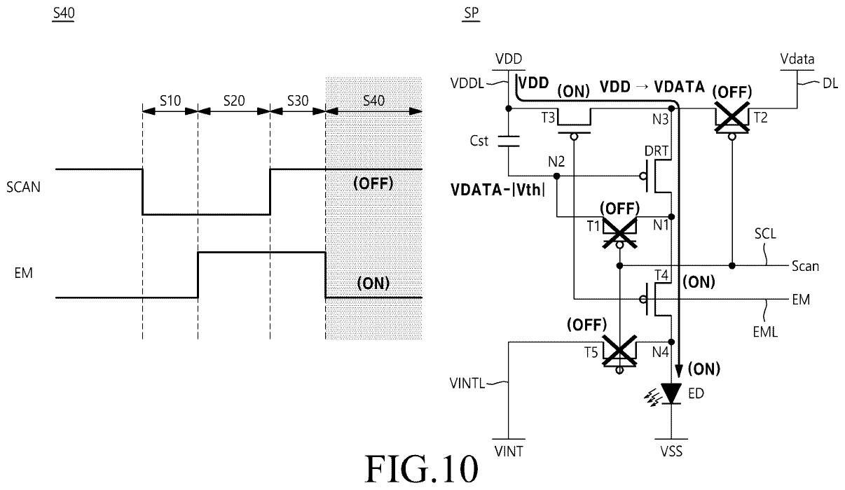

FIG. 10 is circuit and timing diagrams illustrating the driving of the display device 100 during the emission period S40 according to embodiments of the disclosure.

Referring to FIG. 10, during the emission period S40, the first transistor T1, the second transistor T2, and the fifth transistor T5 are turned off by a scanning signal SCAN having a turn-off level voltage. In addition, during the emission period S40, the third transistor T3 and the fourth transistor T4 are turned on by an emission control signal EM having a turn-on level voltage.

Accordingly, during the emission period S40, the voltage of the third node N3 of the driving transistor DRT becomes a high potential voltage VDD. The voltage of the third node N3 has been the data voltage VDATA in the holding period S30, and as the second transistor T2 is turned off in the emission period S40, the voltage of the third node N3 may become a high potential voltage VDD delivered by the third transistor T3.

During the emission period S40, the high potential voltage VDD is supplied to the third node N3, i.e., the source node, of the driving transistor DRT through the turned-on third transistor T3.

During the emission period S40, the source node voltage Vs of the driving transistor DRT satisfies the equation: Vs=high potential voltage VDD=voltage of the third node N3.

During the emission period S40, the voltage Vg of the gate node of the driving transistor DRT satisfies the equation: Vg=VDATA−|Vth|=voltage of the second node N2.

During the emission period S40, current flows to the light-emitting element ED through the driving transistor DRT due to the relationship: Vsd>Vsg>Vth.

During the emission period S40, the equation Vsg=Vs−Vg=VDD−(VDATA−|Vth))=VDD−VDATA+|Vth| is satisfied.

During the emission period S40, the current (Id) flowing through the driving transistor DRT and the current (Ioled) supplied to the light-emitting element ED are the same. Since the driving transistor DRT operates in the saturation region, the expression for the current is as follows:

Id=K[Vsg−|Vth|]²,

where K is (1/2)*μ*Cox (W/L), u is the electron mobility, Cox is the capacitance of the gate oxide layer per unit area, W is the channel width, and L is the channel length.

Specifically, the current supplied to the light emitting element may be determined by Equation 1 below.

$$Ioled = K * {[ Vsg - \vert Vth \vert ]}^{2} = K * {[ VDD - VDATA + \vert Vth \vert - \vert Vth \vert ]}^{2} = K * {[ VDD - VDATA ]}^{2} \qquad [ Equation 1 ]$$

As described above, it may be seen that the current Ioled supplied to the light-emitting element ED is not influenced by the threshold voltage Vth of the driving transistor DRT because the threshold voltage Vth is canceled in Equation 1 of finding the current Ioled supplied to the light-emitting element ED.

That is, since the influence of the threshold voltage Vth is removed during subpixel driving, threshold voltage compensation occurs naturally during the subpixel driving.

The internal compensation subpixel circuit according to embodiments of the disclosure does not perform data writing by a cap coupling method of supplying a data voltage stored in the capacitor applied to the subpixel structure shown in FIG. 3 to the gate node of the driving transistor, but may perform data writing by applying a data voltage directly to the gate node of the driving transistor DRT in the sampling period (the sensing period) S20 in the subpixel structure shown in FIG. 4, thereby being less influenced by the parasitic capacitor.

Furthermore, according to embodiments of the disclosure, the scanning signal line SCL and the emission control signal line EML may be provided in an integrated structure, the number of the lines may be reduced compared to a conventional structure. In other words, as shown in FIG. 4, due to the structure in which the subpixel SP may be driven by only a single scanning signal SCAN and a single emission control signal EM, the number of the plurality of transverse signal lines 1100 (see FIG. 11) including the gate lines GL disposed on the display panel 110 may be reduced. Accordingly, the stretchability characteristics of the display device 100 may be further improved.

FIG. 11 illustrates an example signal line configuration of the display device 100 according to embodiments of the disclosure.

The display device 100 according to embodiments of the disclosure may be a stretchable display device.

As shown in FIG. 11, the display device 100 may have a plurality of line patterns. Each of the plurality of line patterns may have a zigzag shape including a plurality of bent portions.

The plurality of line patterns may include a plurality of transverse signal lines 1100 and a plurality of longitudinal signal lines 1200.

For example, the transverse signal lines 1100 may include scanning signal lines SCL, emission control signal lines EML, and the longitudinal signal lines 1200 may include data lines DL, high-voltage voltage supply lines VDDL, and initializing voltage supply lines VINTL.

The plurality of transverse signal lines 1100 and the plurality of longitudinal signal lines 1200 have a curved shape (e.g., a zigzag shape including a plurality of bent portions). For example, the plurality of horizontal signal lines 1100 and the plurality of vertical signal lines 1200 may have a sine wave shape.

However, the shape of either the plurality of transverse signal lines 1100 or the plurality of longitudinal signal lines 1200 is not limited thereto. For example, the plurality of transverse signal lines 1100 and the plurality of longitudinal signal lines 1200 may extend in a zigzag shape. In another example, the plurality of transverse signal lines 1100 and the plurality of longitudinal signal lines 1200 may have various shapes, for example, in which a plurality of rhombus-shaped substrates are connected to and extend from vertices.

In addition, the number and shape of either the plurality of transverse signal lines 1100 or the plurality of longitudinal signal lines 1200 shown in FIG. 11 are illustrative, and the number and shape of either the plurality of transverse signal lines 1100 or the plurality of longitudinal signal lines 1200 may vary according to the design.

Since the various signal lines 1100 and 1200 have the zigzag shape as illustrated in FIG. 11, the effect of increasing the overall cross-sectional area and overall length of the signal lines, as well as the effect of increasing the flexibility of the signal lines, may be achieved, thereby improving the stretchability characteristics of the display device 100.

In addition, due to the structure in which the subpixel SP may be driven by only a single scanning signal SCAN and a single emission control signal EM as shown in FIG. 4, the number of the plurality of transverse signal lines 1100 including the gate lines GL disposed on the display panel 110 may be reduced. Accordingly, the stretchability characteristics of the display device 100 may be further improved.

Here, the initializing period S10, the sampling period S20, and the holding period S30 correspond to non-emission periods during which the light-emitting element ED does not emit light.

Since no driving current flows through the light-emitting element ED during the non-emission periods, the high potential voltage VDD applied to the corresponding subpixel shows substantially no VDD drop. Accordingly, the voltage stored in the storage capacitor Cst remains stable during the non-emission periods.

In contrast, during the emission period S40, the driving current flows through the light-emitting element ED, thereby resulting in a VDD drop in the high potential voltage VDD applied to the corresponding subpixel. Accordingly, the voltage stored in the storage capacitor Cst may change.

Accordingly, at the same point in time, a subpixel corresponding to the non-emission periods and a subpixel corresponding to the emission period have different changes in the high potential voltage VDD, and thus a luminance deviation may occur between the subpixels.

To solve this problem, the display device 100 of the present disclosure may reduce the luminance deviation caused by the drop of the high potential voltage VDD by constantly maintaining the emission period of the emission control signal EM applied through the gate line.

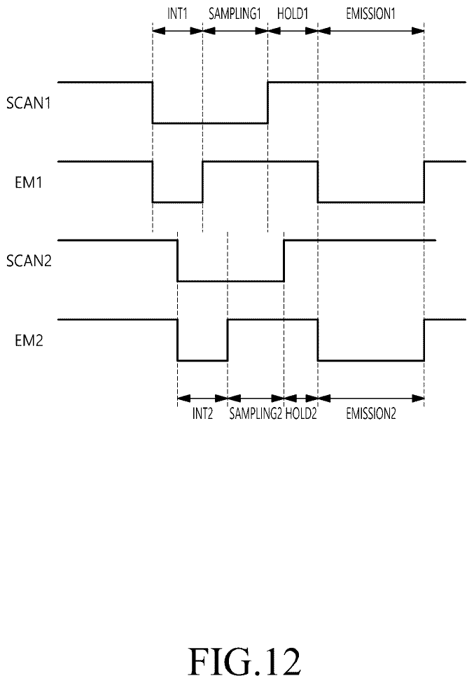

FIG. 12 is a diagram illustrating gate signals applied according to driving timing in which emission periods are maintained the same in a subpixel of the display device according to embodiments of the disclosure.

Here, for ease of understanding, the gate signals (i.e., scanning signals and emission control signals) applied through a first gate line and a second gate line are shown.

Referring to FIG. 12, in display device 100 according to embodiments of the disclosure, the driving time for a subpixel SP driven through the first gate line and the second gate line may include an initializing period, a sampling period, a holding period, and an emission period.

The second gate line may be driven with a delay of a single horizontal blank period than the first gate line.

The initializing period is a period for initializing a voltage on the second node N2 and the third node N3 of the driving transistor DRT connected to the respective gate lines.

During the initializing period, each of the scanning signals SCAN1 and SCAN2 and the emission control signals EM1 and EM2 has a turn-on level voltage. Here, since the first to fifth transistors T1 to T5 are P-type transistors, the turn-on level voltage may be a low-level voltage and the turn-off level voltage may be a high-level voltage.

The operation of the subpixel during the initializing period is the same as shown in FIG. 7.

A first initializing period INT1 caused by the first scanning signal SCAN1 and the first emission control signal EM1 applied through the first gate line and a second initializing period INT2 caused by the second scanning signal SCAN2 and the second emission control signal EM2 applied through the second gate line may have the same time interval.

The sampling period is a period during which the threshold voltage of the driving transistor DRT connected to each gate line is detected and stored. During the sampling period, the scanning signals SCAN1 and SCAN2 have a turn-on level voltage and the emission control signals EM1 and EM2 have a turn-off level voltage.

The operation of the subpixel during the sampling period is the same as shown in FIG. 8.

The first sampling period SAMPLING1 caused by the first scanning signal SCAN1 and the first emission control signal EM1 applied through the first gate line and the second sampling period SAMPLING2 caused by the second scanning signal SCAN2 and the second emission control signal EM2 applied through the second gate line may have the same time interval.

The initializing period and the sampling period may be sensing periods during which the threshold voltage is sensed.

The holding period is a phase (or a period) before the start of the emission period. During the holding period, the scanning signals SCAN1 and SCAN2 and the emission control signals EM1 and SCAN2 have a turn-off level voltage.

The operation of the subpixel during the holding period is the same as shown in FIG. 9.

A first holding period HOLD1 caused by the first scanning signal SCAN1 and the first emission control signal EM1 applied through the first gate line and a second holding period HOLD2 caused by the second scanning signal SCAN2 and the second emission control signal EM2 applied through the second gate line may have different time intervals.

The emission period is a period during which the light-emitting element ED emits light. During the emission period, the scanning signals SCAN1 and SCAN2 have a turn-off level voltage and the emission control signals EM1 and EM2 have a turn-on level voltage. As a result, a path for a current to flow to the light-emitting element ED may be formed.

The operation of the subpixel during the emission period is the same as shown in FIG. 10.

A first emission period EMISSION1 caused by the first scanning signal SCAN1 and the first emission control signal EM1 applied through the first gate line and a second emission period EMISSION2 caused by the second scanning signal SCAN2 and the second emission control signal EM2 applied through the second gate line may have the same time interval.

The display device 100 according to the present disclosure may be operated such that the scanning signals and the emission control signals are applied at different time points depending on the position of the gate lines, but the emission period is the same. In this regard, the initializing period, the sampling period, and the emission period may be maintained the same for the entire gate lines, but the holding period may be controlled differently for the respective gate lines depending on the position of the gate line.

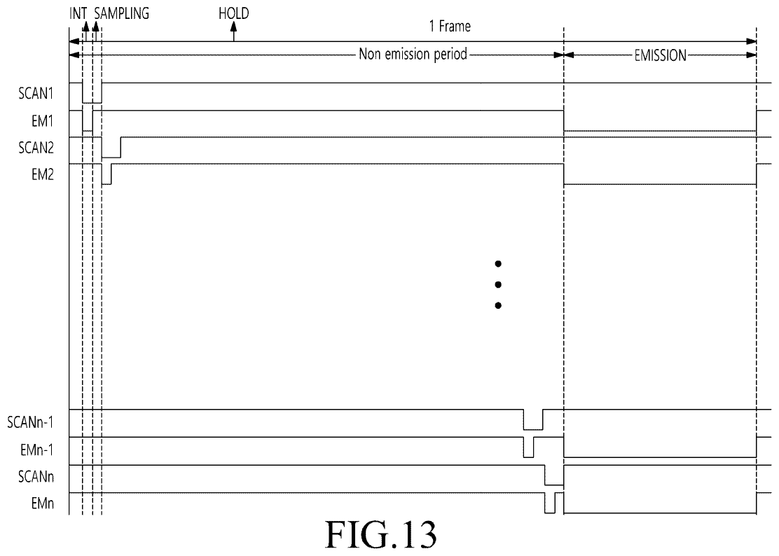

FIG. 13 is a diagram illustrating gate signals that maintain emission periods the same in a single frame in the display panel of the display device according to embodiments of the disclosure.

Referring to FIG. 13, the display device 100 according to embodiments of the disclosure may sequentially apply gate signals (i.e., a scanning signal and an emission control signal) to the entire gate lines of the display panel 110 within a single frame.

When n number of gate lines are disposed on the display panel 110, the gate signals may be applied sequentially from the first gate line to the nth gate line.

For example, a first scanning signal SCAN1 and a first emission control signal EM1 may be applied to the first gate line according to the timing of FIG. 12.

Accordingly, the signal level of each of the first scanning signal SCAN1 and the first emission control signal EM1 may change depending on the initializing period INT, the sampling period SAMPLING, the holding period HOLD, and the emission period EMISSION.

The second scanning signal SCAN2 and the second emission control signal EM2 applied through the second gate line may be delayed by, for example, a single horizontal blank period than through the first gate line.

The signal level of each of the second scanning signal SCAN2 and the second emission control signal EM2 may change depending on the initializing period INT, the sampling period SAMPLING, the holding period HOLD, and the emission period EMISSION.

In addition, an (n−1)th scanning signal SCANn−1 and an (n−1)th emission control signal EMn−1 applied through an (n−1)th gate line may be delayed by a single horizontal blank period than through an (n−2)th gate line.

In addition, an nth scanning signal SCANn and an nth emission control signal EMn applied through the nth gate line may be delayed by a single horizontal blank period than through the (n−1)th gate line.

In this case, the single horizontal blank period refers to the time delay period of the scanning signal and the emission control signal applied through the adjacent gate line, and may vary depending on the magnitude and resolution of the display panel 110.

In the display device 100 of the present disclosure, the initializing period, the sampling period, and the emission period of gate signals applied through each gate line may be generated at the same time interval, but the holding period may be varied depending on the position of the gate line. Accordingly, the emission period of the emission control signals applied through the gate line may have the same time interval.

As a result, the display device 100 of the present disclosure may reduce the luminance deviation depending on the position of the subpixel by the drop of the high potential voltage VDD in the emission period and improve the image quality.

The above-described embodiments of the present disclosure are briefly reviewed as follows.

A display device according to embodiments of the disclosure may include: a display panel on which a data line intersects a gate line, and a plurality of subpixels are arranged; a data driver supplying a data signal to the data line; a gate driver supplying a scanning signal and an emission control signal to the gate line.

Each of the subpixels may include a subpixel circuit. The subpixel circuit including: a driving transistor driving a light-emitting element; a first transistor controlled by the scanning signal and electrically connected to a gate node and a drain node of the driving transistor, a second transistor controlled by the scanning signal and electrically connected to a source node of the driving transistor and the data line; a third transistor controlled by the emission control signal and electrically connected to a high potential voltage supply line and the source node of the driving transistor; a fourth transistor controlled by the emission control signal and electrically connected to the drain node of the driving transistor and the light-emitting element; and a fifth transistor controlled by the scanning signal and electrically connected to an initializing voltage supply line and the light-emitting element.

The subpixel circuit may further comprise a storage capacitor electrically connected to the high potential voltage supply line and the gate node of the driving transistor.

Gate nodes of the first transistor, the second transistor, and the fifth transistor may be connected in common to a single scanning signal line for supplying the scanning signal.

Gate nodes of the third transistor and the fourth transistor may be connected in common to a single emission control signal line for supplying the emission control signal.

The driving time of each of the subpixels may include an initializing period, a sampling period, a holding period, and an emission period.

During the initializing period, an initializing voltage may be applied to the gate node of the driving transistor, and a high potential voltage may be applied to the source node of the driving transistor.

During the initializing period, the initializing voltage may be applied to the gate node of the driving transistor through the fifth transistor, the fourth transistor, and the first transistor.

During the sampling period, the first transistor, the second transistor, and the fifth transistor may be turned on by the scanning signal having a turn-on level voltage, and the third transistor and the fourth transistor may be turned off by the emission control signal having a turn-off level voltage.

During the sampling period, a data voltage may be applied to the source node of the driving transistor, and a voltage on the gate node of the driving transistor may change from the initializing voltage applied to the gate node of the driving transistor during the initializing period into a tracking voltage. The tracking voltage may correspond to a voltage at which an absolute value of a threshold voltage of the driving transistor is subtracted from the data voltage.

During the sampling period, the tracking voltage may correspond to a difference between the data voltage and an absolute value of a threshold voltage of the driving transistor, and a gate-source potential difference of the driving transistor may correspond to the magnitude of the threshold voltage of the driving transistor.

During the holding period, the first transistor, the second transistor, and the fifth transistor may be turned off by the scanning signal having a turn-off level voltage. During the holding period, the third transistor and the fourth transistor may be turned off by the emission control signal having a turn-off level voltage.

During the holding period, a voltage on the drain node of the driving transistor may be increased by a conduction current of the driving transistor.

During the emission period, the first transistor, the second transistor and the fifth transistor may be turned off by the scanning signal having a turn-off level voltage, and the third transistor and the fourth transistor may be turned on by the emission control signal having a turn-on level voltage.

During the emission period, a high potential voltage may be applied to the source node of the driving transistor through the turned-on third transistor, the voltage on the gate node of the driving transistor may correspond to a voltage difference between the data voltage and an absolute value of a threshold voltage of the driving transistor, and a current may flow to the light-emitting element through the driving transistor.

During the emission period, the magnitude of the current flowing to the light-emitting element may be determined irrespective of the threshold voltage of the driving transistor.

At least one of the data line, the gate line, the initializing voltage supply line, and the high potential voltage supply line may have a zigzag shape including a plurality of bent portions.

In the driving time of the subpixels driven through different gate lines, the emission period may have the same time interval.

In the driving time of the subpixels driven through different gate lines, the initializing period, the sampling period, and the emission period may have the same time interval, and the holding period may have different time intervals.

A subpixel according to embodiments of the disclosure may include: a light-emitting element; a driving transistor driving the light-emitting element; a first transistor controlled by a scanning signal and electrically connected to a gate node and a drain node of the driving transistor; a second transistor controlled by the scanning signal and electrically connected to a source node of the driving transistor and a data line; a third transistor controlled by an emission control signal and electrically connected to a high potential voltage supply line and the source node of the driving transistor; a fourth transistor controlled by the emission control signal and electrically connected to the drain node of the driving transistor and the light-emitting element; and a fifth transistor controlled by the scanning signal and electrically connected to an initializing voltage supply line and the light-emitting element.

The subpixel may further comprise a storage capacitor electrically connected to the high potential voltage supply line and the gate node of the driving transistor.

Gate nodes of the first transistor, the second transistor, and the fifth transistor may be connected in common to a single scanning signal line for supplying the scanning signal.

Gate nodes of the third transistor and the fourth transistor may be connected in common to a single emission control signal line for supplying the emission control signal.

One frame time for driving of the subpixel according to embodiments may include: a first period (i.e., an initializing period) in which the source node of the driving transistor has a high potential voltage supplied through the high potential voltage supply line, and the gate node of the driving transistor has an initializing voltage supplied through the initializing voltage supply line, and a second period (i.e., a sampling period) in which the source node of the driving transistor has a data voltage supplied through the data line, and the gate node of the driving transistor has a different tracking voltage from the data voltage.

The tracking voltage may correspond to a voltage at which an absolute value of a threshold voltage of the driving transistor is subtracted from the data voltage.

During the first period, the initializing voltage may be applied to the gate node of the driving transistor through the fifth transistor, the fourth transistor, and the first transistor.

A method of driving a display device according to embodiments of the disclosure may include: a first operation (i.e., an initializing period) of applying a high potential voltage to a source node of a driving transistor in a subpixel including a light-emitting element and a driving transistor and applying an initializing voltage to a gate node of the driving transistor; and a second operation (i.e., a sampling period) of applying a data voltage to the source node of the driving transistor.

In the second operation, the gate node of the driving transistor may have a voltage at which an absolute value of a threshold voltage of the driving transistor is subtracted from the data voltage, and a gate-source potential difference of the driving transistor may correspond to the magnitude of the threshold voltage.

In the second operation, a first transistor connected to a drain node and the gate node of the driving transistor may be turned on.

In the first operation, the initializing voltage may be applied to the gate node of the driving transistor through the first transistor.

According to the embodiments as set forth above, a method of writing an image displaying data voltage directly to the driving transistor during the sensing phase, rather than a method of charging the storage capacitor with a charge corresponding to the image displaying data voltage during a data writing process, may be used so as to be almost completely uninfluenced by a parasitic capacitor.

According to the embodiments, data may be delivered directly to the driving transistor, rather than being delivered to the driving transistor by capacitive coupling, thereby enabling accurate data writing to be accomplished without the influence of a parasitic capacitor.

According to the embodiments, the number of conductive or signal lines may be reduced by forming the scanning signal line and the emission control signal line into an integrated structure. Accordingly, the aperture ratio of the display panel may be increased.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present invention. The above description and the accompanying drawings provide an example of the technical idea of the present invention for illustrative purposes only. That is, the disclosed embodiments are intended to illustrate the scope of the technical idea of the present invention.

What is claimed is:

1. A display device comprising:
a display panel on which a data line intersects a gate line, and a plurality of subpixels are arranged;
a data driver configured to supply a data signal to the data line;
a gate driver configured to supply a scanning signal and an emission control signal to the gate line,
wherein each of the plurality of subpixels comprises a subpixel circuit, the subpixel circuit comprising:
a driving transistor configured to drive a light-emitting element;
a first transistor controlled by the scanning signal, the first transistor electrically connected to a gate node and a drain node of the driving transistor,
a second transistor controlled by the scanning signal, the second transistor electrically connected to a source node of the driving transistor and the data line;
a third transistor controlled by the emission control signal, the third transistor electrically connected to a high potential voltage supply line and the source node of the driving transistor;
a fourth transistor controlled by the emission control signal, the fourth transistor electrically connected to the drain node of the driving transistor and the light-emitting element; and
a fifth transistor controlled by the scanning signal, the fifth transistor electrically connected to an initializing voltage supply line and the light-emitting element.

2. The display device of claim 1, further comprising:
a storage capacitor electrically connected to the high potential voltage supply line and the gate node of the driving transistor.

3. The display device of claim 1, wherein gate nodes of the first transistor, the second transistor, and the fifth transistor are connected to a single scanning signal line that supplies the scanning signal, and gate nodes of the third transistor and the fourth transistor are connected to a single emission control signal line that supplies the emission control signal.

4. The display device of claim 1, wherein a driving time of each of the plurality of subpixels comprises an initializing period, a sampling period, a holding period, and an emission period, and during the initializing period, an initializing voltage is applied to the gate node of the driving transistor, and a high potential voltage is applied to the source node of the driving transistor.

5. The display device of claim 4, wherein during the initializing period, the initializing voltage is applied to the gate node of the driving transistor through the fifth transistor, the fourth transistor, and the first transistor.

6. The display device of claim 4, wherein during the sampling period, the first transistor, the second transistor, and the fifth transistor are turned on by the scanning signal having a turn-on level voltage, and the third transistor and the fourth transistor are turned off by the emission control signal having a turn-off level voltage.

7. The display device of claim 6, wherein during the sampling period, a data voltage is applied to the source node of the driving transistor, and a voltage on the gate node of the driving transistor changes from the initializing voltage applied to the gate node of the driving transistor during the initializing period into a tracking voltage.

8. The display device of claim 7, wherein during the sampling period, the tracking voltage corresponds to a difference between the data voltage and an absolute value of a threshold voltage of the driving transistor, and a gate-source potential difference of the driving transistor corresponds to a magnitude of the threshold voltage of the driving transistor.

9. The display device of claim 7, wherein during the holding period, the first transistor, the second transistor, and the fifth transistor are turned off by the scanning signal having the turn-off level voltage, and during the holding period, the third transistor and the fourth transistor are turned off by the emission control signal having the turn-off level voltage.

10. The display device of claim 7, wherein during the holding period, a voltage on the drain node of the driving transistor is increased by a conduction current of the driving transistor.

11. The display device of claim 7, wherein during the emission period, the first transistor, the second transistor and the fifth transistor are turned off by the scanning signal having the turn-off level voltage, and the third transistor and the fourth transistor are turned on by the emission control signal having the turn-on level voltage.

12. The display device of claim 11, wherein during the emission period, a high potential voltage is applied to the source node of the driving transistor through the third transistor that is turned on, the voltage on the gate node of the driving transistor corresponds to a voltage difference between the data voltage and an absolute value of a threshold voltage of the driving transistor, and a current flows to the light-emitting element through the driving transistor.

13. The display device of claim 12, wherein during the emission period, a magnitude of the current flowing to the light-emitting element is determined irrespective of the threshold voltage of the driving transistor.

14. The display device of claim 1, wherein at least one of the data line, the gate line, the initializing voltage supply line, and the high potential voltage supply line has a zigzag shape comprising a plurality of bent portions.

15. The display device of claim 4, wherein in the driving time of the plurality of subpixels driven through different gate lines, the emission period has a same time interval.

16. The display device of claim 4, wherein in the driving time of the plurality of subpixels driven through different gate lines, the initializing period, the sampling period, and the emission period have a same time interval, and the holding period has a different time interval.

17. A subpixel comprising:
a light-emitting element;
a driving transistor configured to drive the light-emitting element;
a first transistor controlled by a scanning signal, the first transistor electrically connected to a gate node and a drain node of the driving transistor,
a second transistor controlled by the scanning signal, the second transistor electrically connected to a source node of the driving transistor and a data line;
a third transistor controlled by an emission control signal, the third transistor electrically connected to a high potential voltage supply line and the source node of the driving transistor;
a fourth transistor controlled by the emission control signal, the fourth transistor electrically connected to the drain node of the driving transistor and the light-emitting element; and
a fifth transistor controlled by the scanning signal, the fifth transistor electrically connected to an initializing voltage supply line and the light-emitting element.

18. The subpixel of claim 17, further comprising:
a storage capacitor electrically connected to the high potential voltage supply line and the gate node of the driving transistor.

19. The subpixel of claim 17, wherein gate nodes of the first transistor, the second transistor, and the fifth transistor are connected to a single scanning signal line that supply the scanning signal, and gate nodes of the third transistor and the fourth transistor are connected to a single emission control signal line that supplies the emission control signal.

20. The subpixel of claim 17, wherein one frame time for driving the subpixel comprises:
a first period in which the source node of the driving transistor has a high potential voltage supplied through the high potential voltage supply line, and the gate node of the driving transistor has an initializing voltage supplied through the initializing voltage supply line, and
a second period in which the source node of the driving transistor has a data voltage supplied through the data line, and the gate node of the driving transistor has a tracking voltage that is different from the data voltage,
wherein the tracking voltage corresponds to a voltage at which an absolute value of a threshold voltage of the driving transistor is subtracted from the data voltage.

21. The subpixel of claim 20, wherein during the first period, the initializing voltage is applied to the gate node of the driving transistor through the fifth transistor, the fourth transistor, and the first transistor.

22. A method of driving a display device comprising subpixels each comprising a light-emitting element and a driving transistor, the method comprising:
a first operation of applying a high potential voltage to a source node of the driving transistor and applying an initializing voltage to a gate node of the driving transistor; and
a second operation of applying a data voltage to the source node of the driving transistor,
wherein in the second operation of applying the data voltage, the gate node of the driving transistor has a voltage at which an absolute value of a threshold voltage of the driving transistor is subtracted from the data voltage, and a gate-source potential difference of the driving transistor corresponds to a magnitude of the threshold voltage.

23. The method of claim 22, wherein in the second operation of applying the data voltage, a first transistor connected to a drain node and the gate node of the driving transistor is turned on.

24. The method of claim 23, wherein in the first operation of applying the high potential voltage and the initializing voltage, the initializing voltage is applied to the gate node of the driving transistor through the first transistor.
